(19) United States
(12) Patent Application Publication
(10) Pub. No.: US 2019/0275653 A1
(43) Pub. Date: Sep. 12, 2019

(54) Setting Tool with Axially Lockable Drive Shaft, Setting Procedure and Expansion Anchor For This

(71) Applicant: Hilti Aktiengesellschaft, Schaan (LI)

(72) Inventors: Huu Toan NGUYEN, Eichberg (CH); Martin NOSER, Gamprin (LI)

(73) Assignee: Hilti Aktiengesellschaft, Schaan (LI)

(21) Appl. No.: 16/461,278

(22) PCT Filed: Nov. 7, 2017
(86) PCT No.: PCT/EP2017/078451

§ 371 Date: May 15, 2019

(30) Foreign Application Priority Data
Nov. 17, 2016 (EP) 16199246.6

(51) Int. Cl. B25B 31/00; F16B 13/00; F16B 13/12; F16B 13/08

(52) U.S. Cl. CPC B25B 31/00; F16B 13/0833; F16B 13/126; F16B 13/002

(57) ABSTRACT

A setting tool for an expansion anchor, which has an expansion sleeve and an expansion element disposed in the expansion sleeve, includes an internal drive shaft for axially driving forward the expansion element in the expansion sleeve and an external drive shaft surrounding the internal drive shaft for rotational driving and axially driving forward the expansion sleeve into a substrate. The internal drive shaft has an insertion end in a rear area for inserting into a hammer drill. The external drive shaft is disposed in a torque-free manner and is slidable axially on the internal drive shaft. The setting tool further includes a releasable locking device, where an axial sliding of the internal drive shaft relative to the external drive shaft is limitable by the releasable locking device in a forward direction for transferring forward directed axial forces from the internal drive shaft to the external drive shaft.

### CROSS REFERENCE TO RELATED APPLICATIONS

This application claims priority of International Application No. PCT/EP2017/078451, filed Nov. 7, 2017, and European Patent Document No. 16199246.6, filed Nov. 17, 2016, the disclosures of which are expressly incorporated by reference herein.

### BACKGROUND AND SUMMARY OF THE INVENTION

The invention concerns a setting tool for an expansion anchor which exhibits an expansion sleeve and an expansion element for the expansion sleeve arranged for the expansion sleeve, a setting procedure for an expansion anchor, an expansion anchor and a combination of a setting tool and an expansion anchor.

Expansion anchors are known, for example, from DE2617212 A1, which consist of an expansion channel that narrows in the forward direction and an expansion element which is arranged in the expansion channel. For anchoring, the expansion element is driven forward in the expansion channel toward the tapering, where the expansion element expands the expansion sleeve. A tool with journal for axially driving forward the expansion element in the expansion channel is known, for example, from DE102012221114 B3, whereby, a drill can be placed on the journal according to DE102012221114 B3.

In DE7634992 U1, another expansion anchor with an expansion channel that narrows in the forward direction, in which an expansion element is driven forward, is described, whereby the expansion anchor is designed as self-drilling according to DE7634992 U1. In particular, the expansion anchor in DE7634992 U1 on the front-end face of the expansion sleeve exhibits a drill bit and groove-shaped recesses on the back side of the expansion sleeve for transferring a rotary movement to the expansion sleeve.

Additional expansion anchors are known from U.S. Pat. No. 2,707,897 A. This text teaches the use of the expansion anchor in cylindrical drill holes which have been drilled with a drill in advance, and setting into rotation the expansion sleeve toward the tapering of the expansion channel while being driven forward by using a setting tool which engages in the expansion sleeve, whereby a conical undercut is formed in the substrate. For cutting this undercut, the expansion sleeve of U.S. Pat. No. 2,707,897 A exhibit cutting elements at the level of the tapering.

According to JP60099311 U1, the expansion element of an expansion anchor is driven forward toward the tapering of the expansion channel by turning an auxiliary element of the expansion element in an internal thread of the expansion sleeve.

DE102008044124 A1 and DE102007000235 A1 show setting tools for screwable insulation fixings. The setting tools each exhibit two coaxial shafts which are rotary decoupled after reaching a certain depth.

Various anchor device which each exhibit self-drilling setting, are known from U.S. Pat. No. 6,250,866 B1, US2008008553 A1/U.S. Pat. No. 8,662,806 B2/U.S. Pat. No. 8,266,779 B2, EP0845605 B1, U.S. Pat. Nos. 7,070,376 B1, 4,386,882 A, 8,070,405 B2 and EP2366869 A2. DE102011003290 A1 shows a screw that is widened radially in the hole.

DE 90 02 569 U shows a fixing with a sleeve that slides on when setting on a cone converging toward a sleeve, and a setting tool for this fixing. The setting tool works against the sleeve and exhibits a damping ring which passes on the hammer strikes to the sleeve on in a damped manner when using a hammer drill.

DE 1 885 659 U shows a self-drilling expansion fixing which exhibits external notched rings.

EP 1 957 806 A2 and the underlying WO 2007/086988 A2 show an expandable self-drilling screw.

The European patent registration with the registration file number 16159173.0 describes flat insert elements which are drilled into concrete and which can exhibit hard edges for this purpose.

The ICC-ES Evaluation Report ESR-3912, published October/2016, describes an undercut anchor with an expansion sleeve which is pushed in rotary percussive fashion onto a cone arranged in front of the expansion sleeve, whereby an undercut is former in the substrate.

The task of the invention is to indicate a setting tool for an expansion anchor, a procedure for setting an expansion anchor and an expansion anchor, with which good load rates can be achieved with little effort, good manageability and high accuracy.

A setting tool for an expansion anchor according to invention, which exhibits an expansion sleeve and an expansion element for the expansion sleeve arranged in the expansion sleeve, is formed:
With an internal drive shaft for driving the expansion element axially forward in the expansion sleeve,
With an external drive shaft surrounding the internal drive shaft for rotary driving and axially driving the expansion sleeve into a substrate,
Whereby the internal drive shaft exhibits an insertion end in a rear area for insertion into a hammer drill,
Whereby the external drive shaft is torque-proof and is arranged such that it can be axially slid on the internal drive shaft at least at the limits,
And with a releasable locking device, with which an axial sliding forward of the internal drive shaft relative to the external drive shaft can temporarily be limited for transferring axial forces directed forward from the internal drive shaft to the external drive shaft.

A first basic idea of the invention can be found in a setting tool which allows a self-drilling and also self-undercut setting of an expansion anchor with an internal expansion anchor. The setting tool exhibits an internal drive shaft which is coupled with a hammer drill on its back side, and which works on its front side against the expansion element of the expansion anchor, in order to drive the expansion element relative to the expansion sleeve of the expansion anchor. Furthermore, the setting tool exhibits an external drive shaft which surrounds an internal drive shaft, and which works against the expansion sleeve on its front side, in order to drive the expansion sleeve in a rotary or rotary percussive manner into the substrate. The external drive shaft is permanently rotary connected with the internal drive shaft, such that in every phase of the setting procedure, a rotary movement exerted on the internal drive shaft by the hammer drill from the internal drive shaft to the external drive shaft and in turn from the latter onto the expansion sleeve. In particular, the expansion sleeve can thus be turned both in a first phase of the setting procedure, in which the expansion anchor is drilled into the substrate in a self-drilling manner, and in a second phase of the setting procedure, in which the expansion anchor is widened by means of the external drive shaft. The external drive shaft can, at least at the limits, which means at least over a certain axial distance, be slide axially on the inner drive shaft relative to the internal drive shaft, and that is while maintaining the torque-proof connection of the internal drive shaft and the external drive shaft. Due to this axial slidability, in a second phase of the setting procedure, an axial load can be applied exclusively to the expansion element adjacent to the internal drive shaft through axially loading the internal drive shaft by means of the hammer drill, resulting in the expansion element being driven forward relative to the expansion sleeve into the area of the tapering of the expansion channel and the expansion can thus be radially widened. Since the rotary coupling of the two drive shafts continues in the second phase of the setting procedure, despite the axial uncoupling of the two drive shafts, the expansion sleeve can be simultaneously turned along its longitudinal axis when radially widening the expansion sleeve, resulting in substrate as the edge of the expansion sleeve being scraped away in a rotary fashion and an undercut thereby being able to be created in the substrate in an especially effective manner.

Additionally, according to the invention, a releasable locking device is provided for, with which, when the locking device in locked, the axial slideability of the external drive shaft along the internal drive shaft can be temporarily blocked at least to the rear, which means, with which both drive shafts can temporarily be axially coupled in a fixed manner, such that axial forces can be transferred from the internal drive shaft to the external drive shaft, at least to the front. This locking device is locked during the first phase of the setting procedure, which has two effects: for one, axial forces applied by the drill by the internal drive shaft can be transferred from the internal drive shaft to the external drive shaft and from the latter in turn to the expansion sleeve, so that the expansion sleeve can be driven in a rotary percussive manner in the first phase of the setting procedure, which in turn make possible an especially effective drilling of the expansion anchor even into hard substances. For another, by locking the locking device in advance, it can be prevented that the internal drive shaft already has an effect in the expansion element in the first phase, which means that it can be ensured that the widening of the expansion sleeve and the creation of an undercut is not begun until the expansion anchor has already been driven a certain distance into the substrate, which means that an especially well localized undercut is achieved. In the second phase of the setting procedure that follows the first phase, the locking device is released and both drive shafts are thus released for relative axial sliding, which means that as already described above, the internal drive shaft can be pushed forward in the external drive shaft, and the expansion element can be driven forwarded in the expansion sleeve here, without the expansion sleeve drilling further into the substrate. In particular, the locking device can also be designated a switchable locking device. In particular, it can be switched between a locking position and a release position and/or between the locked state of the locking device and the state in which the locking device is released.

The invention thus makes available a setting tool with which an expansion anchor can be drilled into the substrate, an undercut created in the substrate and the expansion anchor anchored in the undercut, and this can be done in a continuous setting procedure, during which it is not necessary to turn the setting tool and it is thus especially easily and reliably be performed, with an especially small number of work steps and/or tools. Based on the arrangement of the expansion anchor in an undercut, especially good load value can be achieved, which also are relatively insensitive to possible bore dust remnants in the drill hole. Moreover, an automatic adjustment to different crack widths in the substrates can be made possible.

In particular, the internal drive shaft is suited for attachment, preferably for direct attachment, to the expansion element.

To the extent radial direction, axial direction and/or circumferential direction is being talked about here, and to the extent we are also speaking of rotation, this is meant to refer in particular to the longitudinal axis of the two drive shafts, so preferably the axis with respect to which the both drive shafts are coaxially arranged. The direction indication “front” and “rear” or “reverse” are meant to be understood uniformly here, related to the same axis, whereby this axis can be in particular the longitudinal axis of the two drive shafts. In particular, the axial driving forward of the expansion element in the expansion sleeve and the axial driving forward of the expansion sleeve to the front, can include, the same spatial direction, in particular the forward direction. In particular, it can be intended that the internal drive shaft is meant for axial, forward directed driving forward of the expansion element in the expansion sleeve and the external drive shaft is meant for rotary driving and axial, forward directed driving forward of the expansion sleeve into the substrate. As is customary, torque-proof arrangement of the external drive shaft on the internal drive shaft means, in particular, that the internal drive shaft turns the external drive with it when turning. The torque-proof arrangement is present, in particular, along the longitudinal axis of the two drive shafts. Since the rotary direction of a drill usually does not change during the drilling process, one torque-free arrangement in one rotary direction can be sufficient. But preferably, the external drive shaft is arranged torque-proof in both opposing directions of rotation in relation to the internal drive shaft, which can be advantageous with respect to application safety and the effort and expense of production. The external drive shaft serves, among other things, the rotary driving of the expansion sleeve along the longitudinal axis or the two drive shafts. The insertion end serves for coupling the downthrust onto the internal drive shaft. The internal drive shaft can preferably exhibit a driver profile. The external drive shaft is preferably shorter in the axial direction than the internal drive shaft. The external drive shaft is formed, in particular, as a hollow shaft, so that the internal drive shaft can enter through the external drive shaft. The internal drive shaft and/or the external drive shaft consists preferably of a metal material, which can also be coated. The internal drive shaft can be formed of one or several pieces. The external drive shaft can also be formed of one or several pieces. The substrate consists preferably of a mineral construction material, in particular, concrete.

The expansion anchor, which is set in a setting procedure with the setting tool, exhibits, in particular, an expansion sleeve with an expansion channel that narrows toward the front, which means with an expansion channel, the cross-section of which decreases in the forward direction. In particular, the expansion anchor can also be designated a drop-in anchor. The expansion anchor also exhibits an expansion element which arranged in the expansion channel. For anchoring, the expansion element is driven forward in the expansion channel toward the tapering, where the expansion element widens the expansion sleeve. In a reverse area, the expansion sleeve exhibits a load application device, in particular, arranged on the inner side of the expansion sleeve, for introducing tensile forces into the expansion sleeve, whereby the load application device is preferably an internal thread. To be expedient, the expansion sleeve is slotted in a front area, in particular, with at least one axially running slit, which can support the widening process. Also, in relation to the support of the widening process, the expansion channel can preferably form a passage opening in the expansion sleeve.

It is especially preferred that the internal drive shaft is, at least in a certain area, a hollow shaft, so, an element in an internal, in particular, an axially running channel. In an especially simple manner, any accumulating bore dust can hereby be directed away during the setting procedure. In particular, the hollow shaft is a hollow shaft for directing bore dust away when setting an expansion anchor. Preferably, the hollow shaft is open in front, in order to permit front-side entry of bore dust. Additionally, or alternatively, radially running channels into the hollow shaft can also be provided for. For reasons of expediency, the setting tool exhibits a rotary opening for directing away material from the rotating internal drive shaft designed as a hollow shaft, so preferably an opening for a sealed transfer of material from the rotating internal drive shaft into a fixed element. For an especially simple design, the opening is preferably arranged axially between the insertion end and the external drive shaft on the internal shaft. Bore dust can be especially effectively be directed away through the hollow shaft, so that an especially clean drill hole can be made with an especially advantageous geometry for the fastening point.

Furthermore, it is especially advantageous if the releasable locking device exhibits at least one radially movable stop element, which can be placed forward into a locking position, in which the stop element is located between the external drive shaft and the internal drive shaft, in order to limit the axial sliding of the internal drive shaft relative to the external drive shaft. In particular, the stop element can be located in the locking position axially between the external drive shaft and the internal drive shaft, in a position that overlaps both the external drive shaft and the internal drive shaft. In the locking position, the external drive shaft can stop at the front side of the stop element and at the back side of the stop element, the internal drive shaft is limited in the external drive shaft in a forward direction by the stop element. Thus, an especially simple and reliable limitation of axial sliding is possible. In particular, it can be provided for that the internal drive shaft exhibits a shoulder pointing forward, preferably a ring shoulder, and that the stop element stops in the locking position at the rear front end of the external drive shaft and at the shoulder pointing forward of the internal drive shaft, which can further decrease the design effort and the production effort and further increase the reliability. The stop element can be moved between the locking position just described and a release position, preferably so that it can be radially moved, whereby in the release position, the limitation of axial sliding caused in the locking position is raised through by the locking device.

It is expedient if the setting tool exhibits a housing with an opening in which the external drive shaft and the internal drive shaft are arranged in a rotatable manner. This housing can be a handle and/or a mount for the expansion anchor, which can further improve manageability.

It is especially preferred that the housing exhibits a mount receiving the radially moveable stop element in the release position. In particular, it can be designed such that the housing holds the stop element in this locking position until the stop element, in particular as the drilling process progresses, ends up axially in the area of the mount and is then pushed into the mount by means of a spring mechanism. In an especially simple and reliable way, an automatic release of the locking devices can be realized when moving from the first phase to the second phase of the setting procedure.

It is expedient if the stop element is, in particular a ring segment-shaped spring, which can independently enter into the mount. In accordance with this design, the spring force of the spring mechanism just described comes from the stop element itself, which can further reduce the design effort.

Another preferred design of the invention is that at least one shoulder, for limiting the sliding of the internal drive shaft relative to the external drive shaft, be provided for on the internal drive shaft, in particular at the end of the setting procedure, preferably at the end of the second phase. In an especially simple manner, it can hereby be ensured that the expansion element is not driven excessively into the expansion sleeve, which can be advantageous with respect to the load behavior. At least the one shoulder can, in particular, be a ring shoulder. In particular, the shoulder mentioned already above can be at least one shoulder. At least one shoulder can be provided for stopping on the external drive shaft or for stopping on the housing. At least one shoulder for stopping on the external drive shaft and at least one shoulder for stopping on the housing. Reliability can be further improved with two shoulders.

Preferably, the internal drive shaft is accessible at its front end, so that the internal drive shaft can work to axially drive the expansion element forward against the expansion element.

It is also especially advantageous that the internal drive shaft extends in a locked state forward past the external drive shaft. The locked state of the locking device can mean, in particular, a state in which the locking device is located in a position relative to the external drive shaft that is temporarily limited, and/or a state in which the stop element is located in the locking position. In accordance with this design, the internal drive shaft can extend beyond the front of the external drive shaft at the start of the first phase of the setting procedure, such that the internal drive shaft can form a journal, on which the expansion sleeve of the expansion anchor can be placed. This makes an especially good centering possible and thus enables reliability and/or especially good manageability. Moreover, in this design, there is an especially small sliding path of the internal drive shaft at the transition between the first phase and the second phase of the setting procedure, and preferably the internal drive shaft can already be adjacent to the expansion element in the first phase. Abrupt movements can hereby be avoided, and the load of the setting tool and/or the drill can be further reduced.

Furthermore, it is especially expedient if the external drive shaft is located in a torque-proof manner and can, at least at the limits, be slid axially on the internal shaft. Such an interlocking exhibits teeth and the outer edge of the internal drive shaft and teeth that correspond to these on the inner edge of the external drive shaft. This makes for an especially simple design. The circumferential interlocking can be a splined locking system, in particular.

Another especially useful further development of the invention is that the external drive shaft exhibits a driver profile in front for a rotary coupling with the expansion sleeve. Such a driver profile makes possible a form-fitting rotary coupling, so a rotary coupling by means of corresponding forms, which permits an especially effective transfer of a rotation. In particular, the driver profile can exhibit front teeth on the front side on the external drive shaft, which means that a coupling can be provided for by means of a face spline. In this case, the counter profile to the driver profile arranged on the expansion anchor, can be produced especially easily. At least one part of the face teeth can preferably be splined.

The invention also concerns a procedure for setting an expansion anchor, which exhibits an expansion sleeve and an expansion element for an expansion sleeve arranged in the expansion sleeve, in a substrate where in a first phase, the expansion sleeve is driven into the substrate while turning, and in a subsequent, second phase, the expansion element is driven forward in the expansion sleeve and the expansion sleeve is hereby widened, whereby the expansion sleeve is simultaneously rotated, in particular, rotated around the longitudinal axis. The expansion anchor can hereby be set self-drilling and self-undercutting, which makes possible especially good load values in an especially simple manner. The undercut, which widens, in particular, moving forward, is created in the second phase, namely through the combination of rotating and widening.

In particular, it can be designed such that both the first phase and the second phase are performed by means of the invented setting tool. Accordingly, the setting tool is used appropriately. Preferably, the setting tool remains in contact with the expansion anchor between the first phase and the second phase.

The invention also concerns an expansion anchor, which exhibits an expansion sleeve with an expansion element for the expansion sleeve arranged in the expansion channel, whereby at the front face of the expansion sleeve at least one cutting edge and at the circumferential surface of the expansion sleeve, at least a second cutting edge is formed. Such an expansion anchor is especially suited for use together with the invented setting tool, and/or in the invented procedure. At least the one cutting edge can support drilling the expansion anchor in especially well in the first phase and at least the second cutting edge can support the creation of the undercut especially well in the second phase.

At least the second cutting edge can extend, in particular, along the longitudinal axis of the expansion anchor, and runs especially preferably parallel to the longitudinal axis of the expansion anchor. In the second phase, an undercut that widens in the forward direction can be created through the combination of rotation and widening. In particular, at least a second cutting edge can overlap with the expansion channel seen from the longitudinal direction of the expansion anchor. The expansion element can hereby especially efficiently radially push the second cutting edge.

The expansion element for the expansion sleeve is preferably arranged in the expansion channel. In particular, the expansion element for the expansion sleeve does not extend beyond the expansion sleeve.

In particular, it can be designed such that the expansion anchor exhibits a cutting element on which both at least one cutting edge and at least a second cutting edge is formed. So, a common cutting element is provided for on which both cutting edges are formed. This can be especially advantageous with respect to the manufacturing process and/or use of material. The cutting element and the expansion sleeve are preferably separate parts. The cutting element can consist, for example, of hard metal. The cutting element is arranged, in particular, on the expansion sleeve. Preferably, several cutting elements are provided for.

In order to make drilling easier, it can be designed such that the front face end of the expansion sleeve forms a tip, which means that it exhibits an opening angle less than 180°. For example, an opening angle of 120°+/−10° can be provided for.

Finally, the invention also concerns the combination of the invented expansion anchor and the invented setting tool. In particular, the invented expansion anchor can be set especially efficiently with the invented setting tool and/or in the invented setting procedure.

The features named in connection with the invented setting tool, the invented setting procedure, the invented expansion anchor and the invented combination are meant to be freely combinable here, so that, for example, features that are explained in connection with the invented setting tool can also be used in the invented setting procedure.

The invention will be described in more detail in the following using preferred design examples which are represented schematically in the attached figures, whereby individual features of the design examples shown in the following as part of the invention can be realized as a rule either individually or in a desired combination.

### BRIEF DESCRIPTION OF THE DRAWINGS

FIG. 1: the side view of a design example of a setting tool;

FIG. 2: the setting tool for FIG. 1 in longitudinal view A-A according to the setting tool of FIG. 1;

FIG. 3: the setting tool for FIGS. 1 and 2 in cross-section view C-C according to the setting tool of FIG. 2:

FIG. 4: the setting tool for FIGS. 1 to 3 in longitudinal section view at the start of the invented setting procedure;

FIG. 5: the setting tool for FIGS. 1 to 3 in a longitudinal section detail view analogous to FIG. 4 at the transition between the first phase and the second phase of the invented setting procedure;

FIG. 6: the setting tool for FIGS. 1 to 3 in a longitudinal section view analogous to FIGS. 4 and 5 at the end of the second phase of the invented setting procedure; and

FIG. 7: an enlarged view of the expansion anchor that can be set with the setting tool in the invented procedure.

### DETAILED DESCRIPTION OF THE DRAWINGS

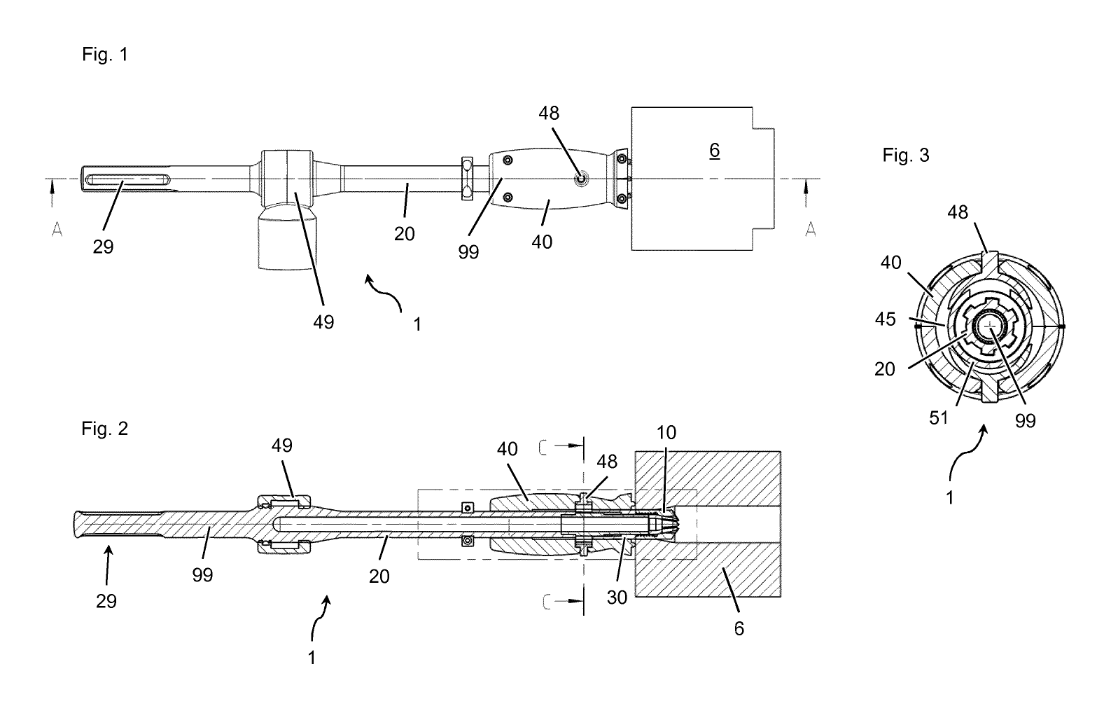

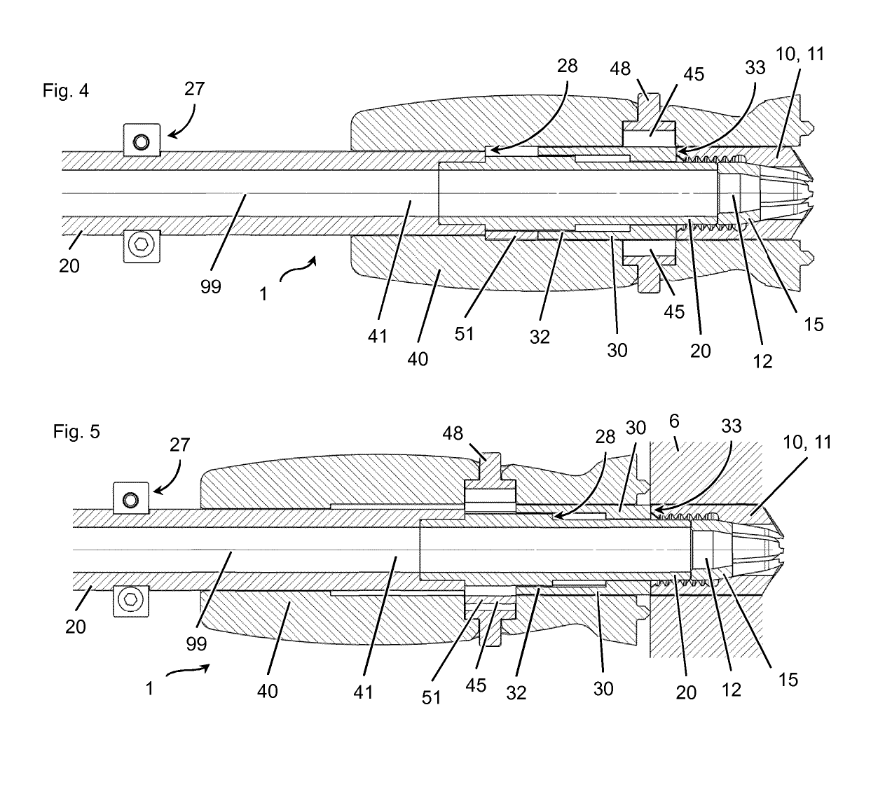

The FIGS. 1 to 6 show an initial design example of the invented setting tool, together with an expansion anchor, whereby for the sake of clarity, a series of details are marked with reference symbols in the front area of the setting tool simply in the detail views of FIGS. 4 to 6.

The setting device 1 exhibits a housing 40, which forms a handle, and which has a passage opening 41. In this passage opening 41, an internal drive shaft 20 and an external drive shaft 30 are arranged, whereby the external drive shaft 30 surrounds the internal drive shaft 20 in a front area of the internal drive shaft 20. Whereas the external drive shaft 30 ends on the back side in housing 40, the internal drive shaft 20 extends from the housing 40 and exhibits an insertion end 29 in a rear area for a connection with the drill chuck of a hammer drill that is not depicted. The internal drive shaft 20, the external drive shaft 30 and the passage opening 41 are coaxially arranged with a longitudinal axis 99.

The external drive shaft 30 is axial within certain limits, which means parallel to the longitudinal axis 99 in one direction, and can be slid on the internal drive shaft 20. A circumferential interlocking 32 is formed between the internal drive shaft 20 and the external drive shaft 30, and this interlocking transfer is a rotational movement from the internal drive shaft 20 to the external drive shaft 30, without interfering with the axial slideability of the external drive shaft on the internal drive shaft 20.

As FIGS. 4 to 6 show in particular, the internal drive shaft 20 is formed of several parts and consists of two axially separate parts, namely of a relatively long rear part which reaches from the insertion end 29 into the housing 40, and a front part.

The setting tool 1 also exhibits a releasable locking device, which in turn exhibits a stop element 51. This stop element 51 can be placed in a locking position, in which it lies, seen in the axial direction, between the internal drive shaft 20 and the external drive shaft 30 and in which it radially overlaps both the internal drive shaft 20 and the external drive shaft 30. In particular, the stop element 51 is located in the locking position in front of the internal drive shaft 20 and behind the external drive shaft 30, preferably in front of a shoulder 28 formed on the internal drive shaft 20 and behind the reverse front end of the external drive shaft 30. When the internal drive shaft 20 is slid forward in the external drive shaft 30, while the stop element 51 is in the locking position, then a point is reached at which the internal drive shaft 20, in particular with its shoulder 28, stops at the stop element 51 and the stop element 51 in turn stops with its front side on the back side of the external drive shaft 30. Due to the dual stop, the stop element 51 blocks a further axial sliding of the internal drive shaft 20 forward, which means that an axial sliding of the internal drive shaft 20 in the external drive shaft 30 in the forward direction is limited by the stop element 51, and a transfer of axial forces directed forward from the internal drive shaft 20 to the external drive shaft 30 is possible by way of the stop element 51. FIG. 4 shows the stop element 51 in the locking position with a shoulder 28 stopping at the stop element 51 and the external drive shaft 30 stopping at the stop element 51. The internal drive shaft 20 extends in this state a bit forward over the external drive shaft 30.

In housing 40, there is a mount 45 for receiving the stop element 51, which abuts to the passage opening 41 radially on the outer side. When the stop element 51 comes axially in front of this mount 45, the stop element 51 can enter into the mount 45 into a release position in a movement directed radially outward. In the release position, the stop element 51 is radially displaced in relation to the two drive shafts 20 and 30, so that the drive shafts 20 and 30 in the release position can no longer stop at the stop element 51 and the stop element 51 thereby no longer limits the axial relative movement of the two drive shafts 20 and 30 to one another. In particular, in the release position, no transfer of axial forces directed forward from the internal drive shaft 20 to the external drive shaft 30 is possible by way of the stop element 51. FIG. 5 shows the setting tool 1 in a state that occurs after the stop element 51 has just entered into the release position in the mount 45.

As shown in FIG. 3, among other things, in the depicted embodiment, the stop element 51 is formed as in a ring shape as a ring shoulder 28 in the mount 45. But other designs are also possible. In particular, in the depicted embodiment, the stop element 51 is formed as a spring, which makes possible an independent entry of the stop element 51 into the mount 45 into the release position by means of spring force, which is stored in the stop element itself 51. But as a rule, arrangements with inelastic stop elements 51 and additional springs are conceivable.

At the front face end of the external drive shaft 30, a driver profile 33 with teeth is formed, which can engage for torque-free coupling between the external drive shaft 30 and an expansion sleeve 11 of the expansion anchor 10 to be set into a corresponding profile on the expansion sleeve 11 of the expansion anchor 10.

FIGS. 4 to 6 show the setting tool 1 in various sequential stages of the invented setting procedure. In particular, FIG. 4 shows the state of the setting tool 1 at that start of the first phase of the setting procedure. In this state, the locking position is located with its stop element 51 in the locking position, the external drive shaft 30 and stop element 51 is adjacent to the shoulder 28 of the internal drive shaft 20, and the internal drive shaft 20 protrudes on the front side a bit outward from the external drive shaft 30, forming a pin. The expansion sleeve 11 of the expansion anchor 10 is slid onto this pin, whereby the pin enters into the inside of the expansion sleeve 11 in the expansion channel 12 of the expansion sleeve, and does so to the extent that the rear face end of the expansion sleeve 11 is adjacent to the external drive shaft 30 and engages with the driver profile 33 of the external drive shaft 30. Preferably, the arrangement is dimensioned such that in this state the pin formed through the internal drive shaft 20 is adjacent to an expansion element 15 of the expansion anchor 10 in the expansion channel 12 of the expansion anchor, or at least is not far removed from the latter.

Now the setting tool 1 is set on the front side of its housing 40 onto a substrate 6 and the internal drive shaft 20 is offset using a hammer drill in a rotary percussive movement. The rotational movement of the internal drive shaft 20 is transferred to the external drive shaft 30 by way of the circumferential interlocking 32 and passed on from this in turn by way of the driver profile 33 to the expansion sleeve 11 of the expansion anchor 10. The percussive movement of the internal drive shaft 20 forward is passed on by way of the stop element 51 of the locking device to the external drive shaft 30 and from the latter in turn to the expansion sleeve 11 by way of its front face end. Subsequently, the expansion sleeve 11 is moved by the setting tool 1 in a rotary percussive manner in the first phase of the setting procedure and hereby drilled into the substrate 6.

When drilling the expansion sleeve 11 into the substrate 6, the internal drive shaft 20, the external drive shaft 30 and the stop element that lies axially between these two drive shafts 20 and 30 in radial overlapping with the drive shafts 20 and 30, move forward relative to the housing. This movement of the drive shafts 20 and 30 and the stop element 51 occurs up to the point that the stop element 51 is situated in axial overlapping with the mount 45 in the housing 40. Due to the spring force, the stop element 51 now jumps radially outward into the mount 45 into a release position of the stop element 51. In this position, the radial overlapping of the stop element 51 with at least one of the two drive shafts, preferably with both drive shafts 20 and 30, is eliminated. Here, the axial transfer of force from the internal drive shaft 20 to the external drive shaft 30 and the expansion sleeve 11 of expansion anchor 10 is eliminated. The first phase of the setting procedure is hereby automatically completed and the second phase begins. The resulting stage is depicted in FIG. 5.

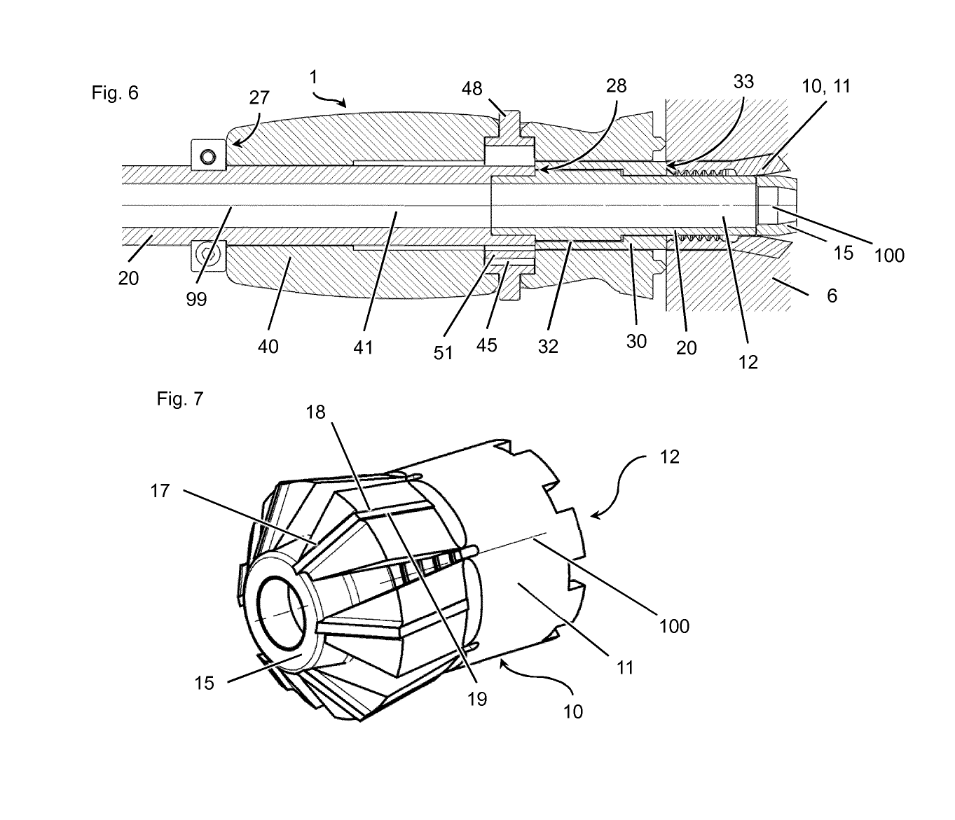

In the second phase, the internal drive shaft 20 impacted by the hammer drill still executes a rotary percussive movement. But since the locking device is now in the release position, only the rotational movement of the internal drive shaft 20 is passed on to the expansion sleeve 11, namely still by way of the circumferential interlocking 32 to the external drive shaft 30 and from the latter to the expansion sleeve 11 by way of the driver profile 33. But the percussive movement of the internal drive shaft 20 is no longer transferred to the expansion sleeve 11, since the internal drive shaft 20 and the external drive shaft 30 are no longer adjacent to one another. The expansion sleeve 11 thus essentially only still executes a rotational movement in the second phase. But since the internal drive shaft 20 can move axially forward relative to the external drive shaft 30 due to the released state of the locking device, the internal drive shaft 20 impacts the expansion element 15 of the expansion anchor 10 percussively in the second phase and drives the expansion element 15 in the expansion channel 12 of the rotating expansion sleeve 11 forward. Here, the expansion element 15 arrives in a front, narrowing area of the expansion channel 12, where the expansion element 15 radially widens the expansion sleeve 11. This widening, in combination with the rotational movement of the expansion sleeve 11, creates an undercut in the substrate 6 at the level of the front area of the expansion sleeve 11 in which the expansion sleeve 11 is shaped. The second phase is preferably ended when the shoulder 28 of the internal drive shaft 20, which is indirectly adjacent in the first phase, namely by way of the stop element 51, to the external drive shaft 30, now directly stops on the external drive shaft 30 and/or when another shoulder 27 arranged offset to the back on the internal drive shaft 20 relative to the housing 40 stops backwards on the housing 40. The resulting state is shown in FIG. 6.

Through the invented setting tool 1, a drill hole can be created with a continuous setting procedure, the expansion anchor 10 set and an undercut created. Here the setting depth and the expansion are ensured by the setting device 1, so that an especially high degree of user-friendliness is ensured. Through the principle of the undercut, higher loads can regularly be transferred at the same fixing-in depth.

The expansion element 15 exhibits preferably a self-limiting angle, such that the setting device 1 can be removed after the expansion sleeve 11 has been successfully widened, without the expansion sleeve 11 moving back into its initial position. On an internal thread arranged on the expansion sleeve 11 pointing into the expansion channel 12, threaded bolts, for example can be inserted after conclusion of the setting procedure.

In order to bring the setting tool 1 back into the initial state for another setting after completion of the second phase of the setting procedure, one or several return elements 48 can be designed in the mount 45 for the stop element 51 with which the stop element 51 can be slid radially inward. In the present design example, two fork-shaped return elements 48 are provided for which each exhibit a return button that protrudes outward on the housing 40.

As especially FIGS. 1 and 2 show, the internal drive shaft 20 is designed in a front area as a hollow shaft that is open toward the front. By way of this hollow shaft, bore dust can be directed away during the setting procedure. Behind the housing 40, a rotational passage 49 is provided for on the internal drive shaft 20 with which the material can be directed away from the hollow shaft.

FIG. 7 shows a detailed view of the expansion anchor 10. As can be seen in FIG. 7, the front face end of the expansion sleeve 11 forms a point, which means that it exhibits an opening angle that is less than 180°, preferably of approximately 120°. The expansion sleeve 11 of the expansion anchor 10 exhibits both face end cutting edges 17 on its exterior, which support the drilling process of the expansion sleeve 11, and a circumferential cutting edge 18, which supports the widening of the expansion sleeve 11. It is especially preferred that the expansion sleeve 11 is equipped with cutting elements 19, preferably made of hard metal, whereby it is preferable that both a face end cutting edge 17 and a circumferential cutting edge 18 are formed on the cutting elements 19. In the depicted design example, the expansion sleeve 11 and the cutting elements 19 form separate parts. But the cutting elements can also be specifically hardened areas of the expansion sleeve 11. On the rear, which means the face end across from the point, the expansion sleeve 11 exhibits a counter profile for the driver profile 33 of the setting device 1.

In order to be able to create a cone-like undercut when rotating and widening the expansion sleeve 11 through the expansion element 15, the circumferential cutting edges 18 extend along the longitudinal axis 100 of the expansion anchor 10, especially preferably as depicted, parallel to this longitudinal axis 100. The circumferential cutting edges 18 overlap one another, seen in the direction of the longitudinal axis 100, in part with the expansion channel 12. In particular, the circumferential cutting edges 18, seen along the longitudinal axis 100, are arranged at the level of the front-end area of the expansion channel 12, in which the cross-section of the expansion channel 12 becomes smaller toward the front end of the expansion channel 12.

1.-15. (canceled)

16. A setting tool for an expansion anchor which has an expansion sleeve and an expansion element disposed in the expansion sleeve, comprising:
an internal drive shaft for axially driving forward the expansion element in the expansion sleeve;
an external drive shaft surrounding the internal drive shaft for rotational driving and axially driving forward the expansion sleeve into a substrate;
wherein the internal drive shaft has an insertion end in a rear area for inserting into a hammer drill;
wherein the external drive shaft is disposed in a torque-free manner and is slidable axially on the internal drive shaft; and
a releasable locking device, wherein an axial sliding of the internal drive shaft relative to the external drive shaft is limitable by the releasable locking device in a forward direction for transferring forward directed axial forces from the internal drive shaft to the external drive shaft.

17. The setting tool according to claim 16, wherein the internal drive shaft, at least in part, is a hollow shaft and wherein the setting tool has a rotational passage for directing away material from the internal drive shaft.

18. The setting tool according to claim 16, wherein the releasable locking device has a radially moveable stop element which is placeable to limit the axial sliding of the internal drive shaft relative to the external drive shaft forward into a locking position, in which locking position the radially moveable stop element is located between the external drive shaft and the internal drive shaft.

19. The setting tool according to claim 18 further comprising a housing with a passage opening in which the external drive shaft and the internal drive shaft are disposed and are free to rotate, wherein the housing has a mount for receiving the radially moveable stop element in a release position.

20. The setting tool according to claim 19, wherein the radially moveable stop element is a ring segment-shaped spring which can independently enter into the mount.

21. The setting tool according to claim 16, wherein a shoulder is disposed on the internal drive shaft to limit displacement of the internal drive shaft forward relative to the external drive shaft.

22. The setting tool according to claim 16, wherein the internal drive shaft extends forward beyond the external drive shaft when the releasable locking device is in a locked position.

23. The setting tool according to claim 16, wherein the external drive shaft is disposed in the torque-free manner by circumferential interlocking.

24. The setting tool according to claim 16, wherein the external drive shaft has a driver profile at a front end of the external drive shaft for rotary coupling with the expansion sleeve and wherein the driver profile has front teeth disposed at a front face end of the external drive shaft.

25. A method for setting an expansion anchor in a substrate, wherein the expansion anchor has an expansion sleeve and an expansion element disposed in the expansion sleeve, comprising the steps of:
in a first phase, driving the expansion sleeve into the substrate while rotating the expansion sleeve; and
in a second phase that is subsequent to the first phase, driving the expansion element forward in the expansion sleeve and consequently widening the expansion sleeve and simultaneously rotating the expansion sleeve.

26. The method according to claim 25, wherein both the first phase and the second phase are performed using a setting tool as claimed in claim 16.

27. An expansion anchor, comprising:
an expansion sleeve with an expansion channel that tapers toward a front; and
an expansion element disposed in the expansion channel;
wherein a front face end of the expansion sleeve has a first cutting edge and a circumferential surface of the expansion sleeve has a second cutting edge.

28. The expansion anchor according to claim 27, wherein the first cutting edge and the second cutting edge are formed on a cutting element.

29. The expansion anchor according to claim 27, wherein the front face end of the expansion sleeve forms a point.

30. A setting tool according to claim 16 in combination with an expansion anchor according to claim 27.
